(19) United States
(12) Patent Application Publication
(10) Pub. No.: US 2009/0066657 A1
(43) Pub. Date: Mar. 12, 2009

(54) CONTACT SEARCH TOUCH SCREEN

(76) Inventors: Richard Charles Berry, West Bloomfield, MI (US); Michael James Andrews, Plymouth, MI (US); Michael Dean Tschirhart, Ann Arbor, MI (US)

Correspondence Address: VISTEON/BRINKS HOFER GILSON & LIONE, 524 South Main Street, Suite 200, Ann Arbor, MI, 48104, US

(21) Appl. No.: 11/854,007

(22) Filed: Sep. 12, 2007

(51) Int. Cl. G06F 3/041

(52) U.S. Cl. 345/173

(57) ABSTRACT

A system includes an active touch surface, the active touch surface being configured to receive a selection action from a pointer, an x-y coordinate system, the x-y coordinate system being configured to output position data relating to the position of the pointer on the active touch surface, and a processing device. The processing device in communication with the x-y coordinate system and the active touch surface, the processing device being configured to determine the position of the pointer using the position data, and the processing device being configured to determine if the active touch surface has received the selection action from the pointer

### BACKGROUND

1. Field of the Invention

The invention relates to electronic touch screens and more specifically to electronic touch screens found in automobiles.

2. Description of the Known Technology

A traditional electronic touch screen combines the functions of screen location sensing and control activation into a single operation. When a portion of the touch screen is touched, the x-y coordinates associated with the touch point are correlated to a specific underlying control which is simultaneously activated. Thus, when touching a certain portion of the screen, any associated functions located at the touch point are simultaneously selected.

However, there is a significant drawback to current touch screens. Combining screen location sensing and control activation into a single operation results in restricted product utility since visual feedback to the user can only be provided after a control has been activated. As it is well known in the art, an external cursor device, such as a mouse, connected to a personal computer, allows the user of the personal computer to both move a cursor displayed on a display device to a desired location and select any function located underneath the cursor, thus dividing location sensing and control activation into separate operations.

As stated previously, existing touch screens only allow the user to select the underlying operation and do not allow the user to move a cursor within the display area of the touch screen. Although it was previously mentioned that one solution to this problem is the implementation of an external cursor device, such as mouse, this implementation is undesirable in an automobile. For example, automobiles while idling create vibrations, making the use of an external cursor device difficult. These vibrations become even more pronounced as the automobile travels. Additionally, controls of an automobile are generally fixedly attached to interior portions of the automobile, such as the instrument panel, so prevent these controls from being a danger to the occupants in the event of automobile accident.

### BRIEF SUMMARY

In overcoming the enumerated drawbacks of the prior art, an active touch system is disclosed. The active touch system includes an active touch surface, the active touch surface being configured to receive a selection action from a pointer, an x-y coordinate system, the x-y coordinate system being configured to output position data relating to the position of the pointer on the active touch surface, and a processing device. More simply, the x-y coordinate system is utilized for location sensing while the active touch surface functions to determine control activation. The processing device in communication with the x-y coordinate system and the active touch surface, the processing device being configured to determine the position of the pointer using the position data, and the processing device being configured to determine if the active touch surface has received the selection action from the pointer.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a plan view of the active touch system embodying the principles of the present invention;

FIG. 2 is an exploded view of the active touch system of FIG. 1;

FIG. 3 is a block diagram of a front view of the active touch system embodying the principles of the present invention; and

FIG. 4 is a block diagram of a side view of the active touch system of FIG. 3.

### DETAILED DESCRIPTION

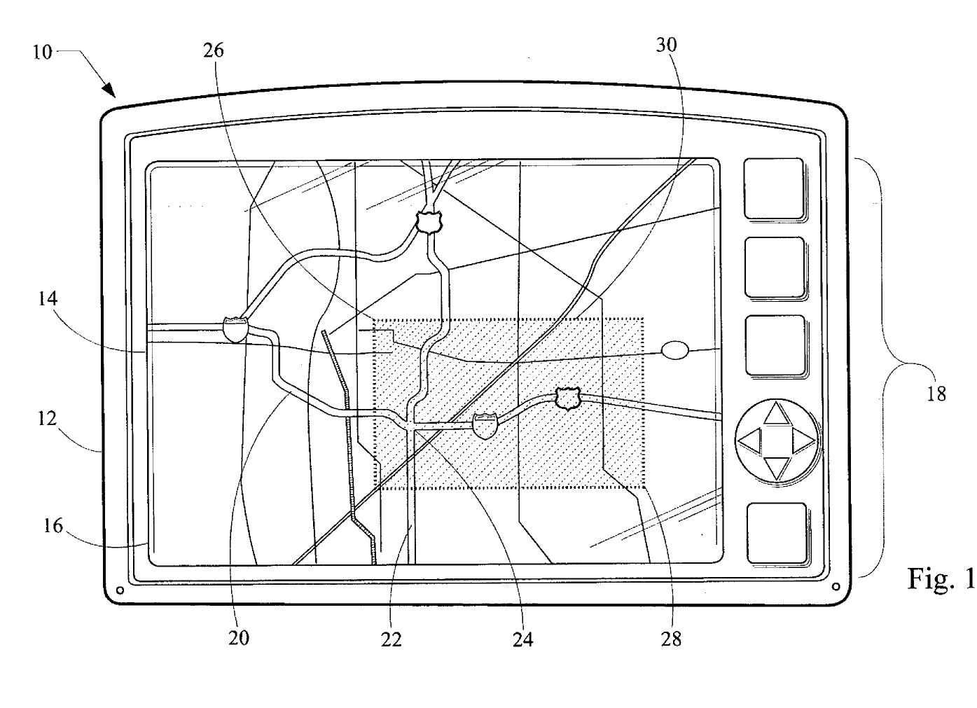

Referring to FIG. 1, an active touch system 10 is shown. The system 10 includes a housing 12 defining an opening 14. Within the opening 14 is located a display area 16. The display area 16 is capable of displaying a 2-dimensional image, such an image displayed by a liquid crystal display (“LCD”), a plasma display, a regular projection tube display, or any other type of display capable of displaying a 2-dimensional image. Located around the perimeter of the housing 12 is a plurality of controls 18 for accessing information to be displayed in the display area 16. The controls 18 are generally of a push button design, but any type of control capable of accessing information to be displayed in the display area 16 may be utilized. Generally, the active touch system 10 is located within the occupant compartment of an automobile and may function as an automobile vehicle navigation system.

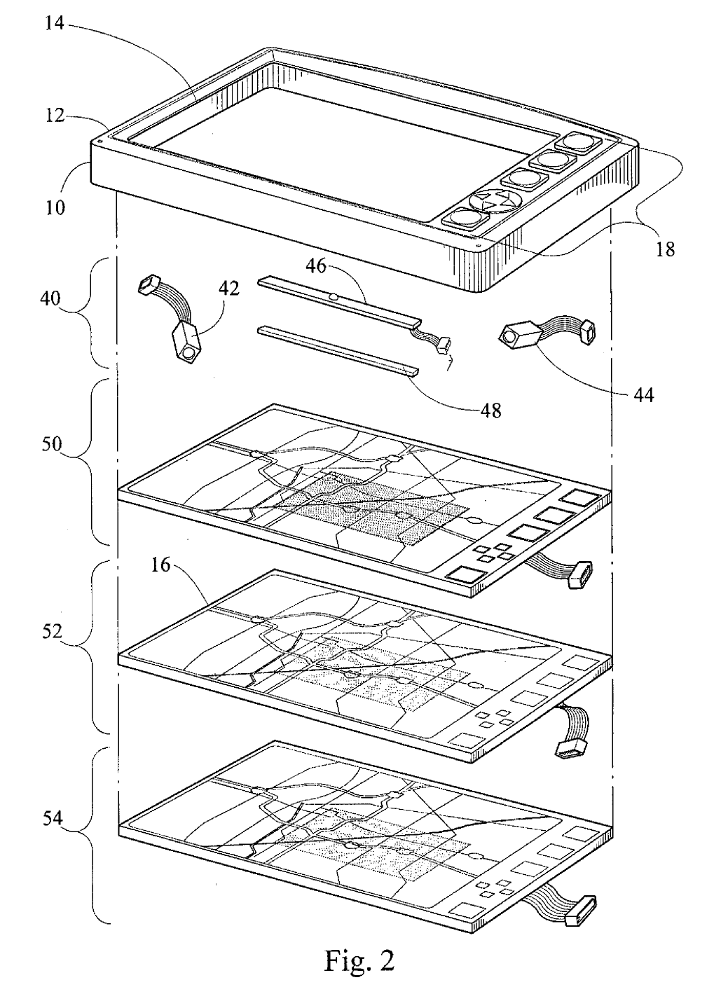

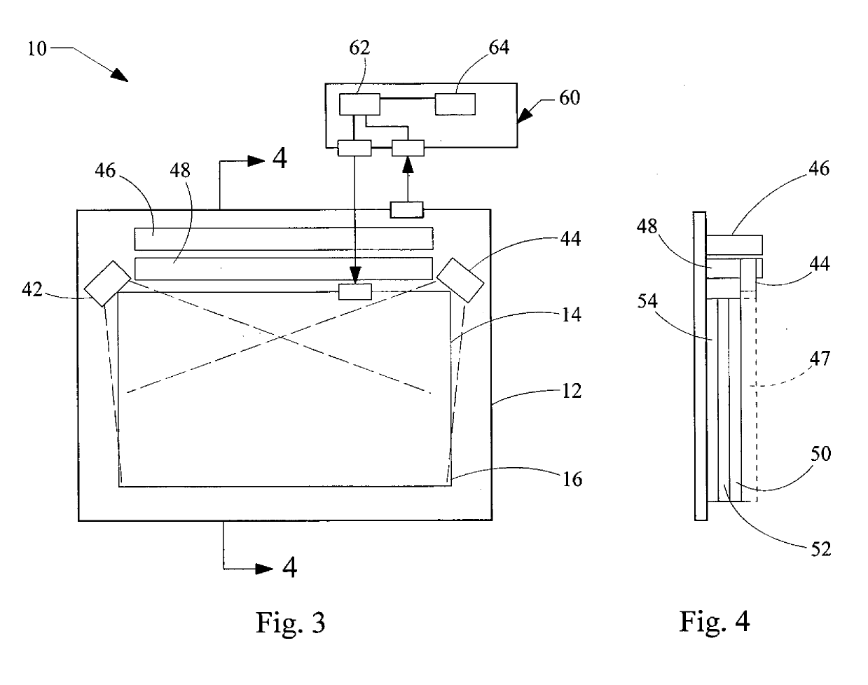

Referring to FIG. 2, an exploded view of the system 10 is shown. As stated previously, the system 10 includes a housing 12 defining an opening 14 and controls 18 which may be located on or near the perimeter of the housing 12. Further disassembly of the system 10 reveals four unique layers. The first layer is an x-y coordinate system 40. The x-y coordinate system 40 includes a camera system having a first camera 42 and a second camera 44. As best shown in FIG. 3, the fields of view 43, 45 of the cameras 42, 44, respectively, are substantially parallel to the plane defined by the opening 14 of the housing 12 and are positioned in a triangular fashion, so as to be able to capture images of a pointer, such as a fingertip of a user. Essentially, the cameras are located near perimeter corners of the opening 14. As best shown in FIG. 4, as the pointer enters a gesture area 47 near the opening 14, the cameras will capture images of the pointer and, as will be explained later, these images will be relayed to a processor which will determine the location of the pointer within the gesture area 47 based on the images captured by the cameras 42, 44

Referring back to FIG. 2, the x-y coordinate system 40 may also include a light source 46, such as an infrared light source, and a light pipe 48. The light source 46 and the light pipe 48 work in concert to provide lighting such that the cameras 42, 44 are able to capture images of the object that can be later processed by a processor. Generally, if the cameras 42, 44 capture images that do not clearly show the pointer, the processor will be unable to determine the position of the pointer based on the captured images. Incorporating the light source 46 and the light pipe 48 results in captured images that clearly show the pointer. An infrared light source is preferred because infrared light sources can be perceived by the cameras 42, 44, while not being perceived by the human eye.

Located just below the x-y coordinate system 40 is an active touch surface 50. The active touch surface 50 is a touch surface commonly known in the art. When the active touch surface 50 is depressed by an object, such as the pointer, the active touch surface 50 will output a signal indicative as to the location of where the pointer touched the active touch surface 50.

The utilization of both the x-y coordinate system 40 and the active touch surface 50 results in effectively separating the operations of locations sensing and control activation. More specifically, the operation of location sensing is provided by the x-y coordinate system 40, while the operation of control activation is provided by the active touch surface 50.

Located below the active touch surface 50 is a display device 52 having a viewing area, defining the display area 16. As stated previously the display device is generally an LCD display but may be a display of any suitable type. Because the display area 16 of the display device 52 must be visible to the user through the opening 14 of the housing 12, the active touch surface 50 is a generally a substantially transparent active touch surface 50.

Located beneath the display device 52 is an optional feedback device 54. The feedback device 54 may be a haptic system configured to provide touch feedback at the occurrence of an action. For example, assume that the display device 52 is displaying several push buttons. As the user moves a pointer across the display area 16 of the display device 52, the feedback device 54 may provide a slight “rumble” to the user indicating that the user is a near a display button 16. Additionally, the feedback device 54 may be configured such that when the pointer depresses on the active touch surface 50, the feedback device 54 will provide a slight rumble, indicating to the user that a selection has been made.

Referring to FIGS. 3 and 4, block diagrams of the front and side, respectively, of the system 10 is shown. As stated previously, the system 10 includes a housing 12 defining an opening 14 for a display area 16. The system 10 also includes two cameras 42, 44 as well as a light source 46 along with a light pipe 48. Here, the system 10 shows that the cameras 42, 44 are positioned in a triangular orientation allowing the cameras to each individually have a full field of view encompassing the entire display area 16. By so doing, as the pointer is placed within the field of view of the cameras 42, 44, a calculation can be made as to the location of the pointer within the gesture area 47.

Additionally, it is noted that the cameras 42, 44, the active touch surface 50, the LCD display 52, and the optional feedback device 54 are connected to a computer system 60. The computer system 60 generally includes a processor 62 in communication with at least a memory device 64 containing instructions to configure the processor to perform any one of a number of instructions related to operation of the system 10. The display device 52 is connected to the processor preferably through a video graphics array (“VGA”) interface, however, any video graphics display adaptor may be used. Additionally, the cameras 42, 44, active touch surface 50, and the optional feedback device 54 may be placed in communication with the processor 62 via a universal serial bus (“USB”) interface.

As stated in the background section, it is often desirable to allow the user of the system 10 not only selected underlying operation as well as be able to move a cursor within the display area 16. For example, referring back to FIG. 1, assume that a map is displayed within a display area 16. The map displays a substantially east-west highway 20 and a substantially north-south highway 22. Also assume that the user of the system 10 wishes to zoom into the intersection 24 defined by highways 20, 22. The hardware components of the system 10 allow the user to select a first point 26, with a pointer, such as the user's fingertip. Furthermore, since location sensing and control activation are separate functions through the utilization of both the x-y coordinate system 40 and the active touch surface 50, the system 10 is capable of allowing the user to select the first point 26 (control activation) and drag with the pointer (location sensing) to a second point 28, thereby defining an area of interest 30. Thereafter, the system 10 can perform any one of a number operations. In this example, the system 10 could magnify the area of interest 30 and display the magnified area of interest within the display area 16.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A system comprising:
an active touch surface, the active touch surface being configured to receive a selection action from a pointer;
an x-y coordinate system separate from the active touch surface, the x-y coordinate system being configured to output position data relating to the position of the pointer on the active touch surface; and
a processing device in communication with the x-y coordinate system and the active touch surface, the processing device being configured to determine the position of the pointer using the position data, and the processing device being configured to determine if the active touch surface has received the selection action from the pointer.

2. The system of claim 1, further comprising a display device having a viewing area, wherein the active touch surface overlays at least a portion of the viewing area.

3. The system of claim 2, wherein the display device is a liquid crystal display device.

4. They system of claim 2, wherein the x-y coordinate system overlays the active touch surface.

5. The system of claim 1, wherein:
the x-y coordinate system is camera system having at least two cameras, each of the at least two cameras having a field of view looking across the active touch surface, each of the at least two cameras being oriented to capture images of the active touch surface; and
the processing device is configured to determine the position of the pointer appearing in the images.

6. The system of claim 4, wherein the at least two cameras are orientated in a triangular configuration.

7. The system of claim 4, further comprising a lighting system positioned to provide light to the active touch surface.

8. The system of claim 1, further comprising:
a feedback device for providing feedback to a user; and
the processing device being configured to provide feedback to the user via the feedback device at the occurrence of an action.

9. The system of claim 8, wherein the feedback device is an audio system configured to provide audio feedback at the occurrence of the action.

10. The system of claim 8, wherein the feedback device is a haptic system configured to provide touch feedback at the occurrence of the action.

11. The system of claim 8, wherein the action is the selection action of the active touch surface from the pointer.

12. The system of claim 8, wherein the action is the movement of the pointer into a portion of the active touch surface representing an edge of a control button.

13. A method for determining the position and action of a pointer:
determining the position of the pointer on an active touch service using position data provided by an x-y coordinate system; and
determining if the active touch surface has received a selection action from the pointer using a selection input from the active touch surface.

14. The method of claim 13, further comprising a display device having a viewing area, wherein the active touch surface overlays at least a portion of the viewing area.

15. The method of claim 14, wherein the display device is a liquid crystal display device.

16. The method of claim 13, further comprising the step of determining the position of the pointer appearing in images outputted by the x-y coordinate system, wherein the x-y coordinate system is camera system having at least two cameras, each of the at least two cameras having a field of view looking across the active touch surface, each of the at least two cameras being oriented to capture images of the active touch surface.

17. The method of claim 16, wherein the at least two cameras are orientated in a triangular configuration.

18. The method of claim 16, further comprising the step of providing light to the active touch surface.

19. The method of claim 13, further comprising the step of providing feedback to the user via a feedback device at the occurrence of an action.

20. The method of claim 19, wherein the step of providing feedback further comprises the step of providing audio feedback at the occurrence of the action.

21. The method of claim 19, wherein the step of providing feedback further comprises the step of providing touch feedback at the occurrence of the action.

22. The method of claim 19, wherein the action is the selection action of the active touch surface from the pointer.

23. The method of claim 19, wherein the action is the movement of the pointer into a portion of the active touch surface representing an edge of a control button.
